(19) United States
(12) Patent Application Publication
(10) Pub. No.: US 2011/0239395 A1
(43) Pub. Date: Oct. 6, 2011

(54) WIPER ASSEMBLY WITH ROTATABLE WIPER ARM

(75) Inventor: Eckart Wunsch, Unterreichenbach (DE)

(73) Assignee: NV BEKAERT SA

(21) Appl. No.: 13/139,485

(22) PCT Filed: Dec. 4, 2009
(86) PCT No.: PCT/EP09/66433

§ 371 Date: Jun. 13, 2011

(30) Foreign Application Priority Data
Jan. 28, 2009 (EP) 09151522.1

(51) Int. Cl. B60S 1/32

(52) U.S. Cl. 15/250.32

(57) ABSTRACT

A wiper assembly (3) is provided comprising a wiper arm (4) having a longitudinal axis (X-X) and arranged to carry a wiper blade (8). The wiper arm (4) comprises a free end (5). A support member (6) rotatable around a first axis of rotation (A-A) extends substantially transversely to said longitudinal axis (X-X) of the wiper arm (4), and is arranged to support the wiper arm (4). The support member (6) comprises a passage (13) into which the free end (5) of the wiper arm (4), at least partly, projects. The free and (5) of the wiper arm (4) and the passage (13) define a second axis of rotation (B-B) about which the wiper arm (4) is rotatable. The second axis of rotation (B-B) is different from the longitudinal axis (X-X) of the wiper arm (4).

### FIELD OF THE INVENTION

The present invention relates to a wiper assembly, in particular a wiper assembly suitable for wiping windows of motor vehicles.

### BACKGROUND OF THE INVENTION

Wiper assemblies for use with motor vehicles and arranged to wipe windows thereof are generally known. Such a known conventional wiper assembly comprises a rotatably driven support member that is connected to a wiper arm, which in turn carries the wiper blade. The wiper arm is connected to the support element by means of a hinge, which allows the wiper arm to be swung away from the window of the motor vehicle in order to allow the wiper blade to be replaced or to clean the windshield. The known wiper assembly comprises a C-shaped hook that is connected to the support member at one free end thereof and that is connected to a tension spring on the opposite free end thereof. The tension spring in turn is connected to the wiper arm and tensions the wiper arm with the wiper blade on the window of the motor vehicle.

A concern of the known conventional wiper assembly is that in order to replace the wiper blade the wiper arm must be swung away from the window against the pulling force of the tension spring. On the one hand this puts mechanical strain on the connection points of the support member and the wiper arm, resulting in mechanical wear and tear. On the other hand this also introduces the risk that the wiper arm suddenly swings back into its original position under the force exerted by the tension spring when the wiper blade is being removed, which may cause the wiper arm without the wiper blade attached to strike the window forcefully and damage the window pane.

A solution for the above-mentioned concern with the conventional wiper assembly has been proposed in U.S. Pat. No. 4,463,471 and which discloses that the support member comprises a passage that extends transversely to the axis of rotation of the support member. The wiper arm supports a wiper blade and is inserted at a free end in said passage of the support member, such that the wiper arm can be rotated about its longitudinal axis with respect to the support member. The wiper arm extends transversely to the rotation axis of the support member. At its free end the wiper arm is provided with a plug that can be housed in a socket in the support member so as to lock the rotation of the wiper arm. The wiper arm is moveable in axial direction thereof against a bias of a spring member, which spring urges the plug into the socket. By pulling the wiper arm out of the socket in axial direction, the plug comes out of the socket and the wiper arm can be rotated around its longitudinal axis, which enables replacement of the wiper blade.

A concern of the solution presented in U.S. Pat. No. 4,463,471 is associated with the fact that the wiper arm of U.S. Pat. No. 4,463,471 also functions as a leaf spring that pushes the wiper blade against the window pane of the motor vehicle. In order to replace the wiper blade, prior to pulling the wiper arm in axial direction, the wiper arm must be manually lifted of the window of the motor vehicle against its resilient force by elastically deforming it to create sufficient clearance between the wiper blade and the window. This means that a user must continue to exert both a pulling force in axial direction of the wiper arm and in a direction perpendicular to the window pane, and thus substantially perpendicular to the axial direction of the wiper arm, while rotating the wiper arm. This requires coordination of multiple movements of a user while exerting force. Furthermore, the lifting force exerted on the wiper arm will yield a bending moment in the passage which will hinder smooth rotation of the wiper arm.

With U.S. Pat. No. 4,463,471 there is a latent chance to deform the wiper arm (leaf spring) permanently when pulling too far from the windshield. This would lead to a plastic deformation of the wiper arm which in turn can lead to complete loss of wiping performance.

The chance for deformation increases in winter time when wiper blades tend to freeze to the windshield when the car is parked outside.

### OBJECT OF THE INVENTION

It would therefore be desirable to provide an improved wiper assembly which is very easy to use when replacing a wiper blade and at least alleviates the indicated concerns.

### SUMMARY OF THE INVENTION

To better address one or more of these concerns, a wiper assembly is provided which comprises a wiper arm having a longitudinal axis and which is arranged to carry a wiper blade. The wiper arm comprises a free end. This free end forms one single piece with the wiper arm or, alternatively, is fixedly connected to the wiper arm. Further, the assembly comprises a support member that is rotatable around a first axis of rotation and which extends substantially transversely to the longitudinal axis of the wiper arm. The support member is arranged to support the wiper arm through the free end. The support member comprises a passage into which the free end of the wiper arm, at least partly, projects. The free end of the wiper arm and the passage define a second axis of rotation about which the wiper arm is rotatable. The second axis of rotation is different from the longitudinal axis of the wiper arm.

By providing that the axis about which the wiper arm can rotate is different from its longitudinal axis, a clearance between a wiper blade attached to the wiper arm and a window pane of a motor vehicle will automatically be created as soon as the wiper arm is rotated. Hence it is not required to pull the wiper arm of the window pane in order to create a clearance to allow rotation of the wiper arm. It is hereby understood that with the wiper assembly of U.S. Pat. No. 4,463,471 the longitudinal axis of the wiper arm coincides with the axis of rotation.

The free end of the wiper arm which projects in the passage of the support member may be an integral part of the wiper arm or may be a separate part fixed to the wiper arm.

In an embodiment of the wiper assembly the second axis of rotation is substantially parallel with the longitudinal axis of the wiper arm, allowing for an easy rotation of the wiper arm close to a window pane of a motor vehicle.

In an embodiment of the wiper assembly the second axis of rotation is angled with respect to the longitudinal axis of the wiper arm. In this manner the rotation of the wiper arm will at the same time result in the wiper arm being swung away from the window pane of a motor vehicle, provided that the angle of the second axis of rotation is directed in an upward direction from the windowpane to be wiped.

In an embodiment of the wiper assembly the passage has a substantial circular cross-section and the free end of the wiper arm projecting, at least partly, in said passage has a corresponding cross-section, so that the free end of the wiper arm may function as a hinge.

In an embodiment of the wiper assembly the passage extends into an interior space of the support member and the free end of the wiper arm projects into said interior space, and wherein the wiper assembly further comprises releasable coupling means arranged, at least partly, in the interior space acting on the free end of the wiper arm and said support member for releasingly coupling the wiper arm to the support member. In this manner the coupling means can be hidden from view and a very compact design of in particular the support member is obtained. Furthermore, the coupling means are in this manner protected from the environment, in particular from dirt that may compromise the proper working of the coupling means.

In an embodiment of the wiper assembly the free end of the wiper arm is axially moveable in said passage, and wherein the coupling means comprise a resilient member for urging the wiper arm against the support member. This provides a convenient way of releasingly coupling the wiper arm and the support member to each other.

In an embodiment of the wiper assembly the resilient member is a helical spring arranged between and acting upon a distal end of the wiper arm and a wall of said interior space, yielding a very cost-effective design.

In an embodiment of the wiper assembly comprising locking means are provided that are arranged to lock the wiper arm to the support member in at least an operable position of the wiper assembly, so that during use of the wiper assembly the wiper arm will stay coupled to the support member and will not become detached due to the movements of the wiper arm.

In an embodiment of the wiper assembly the locking means are further arranged to lock the wiper arm to the support member in a non-operable position of the wiper assembly different from the operable position. This allows that the wiper arm is locked in a position in which the wiper blade can be conveniently replaced and that it is not required for a user to manually hold the wiper arm in the non-operable position.

In an embodiment of the wiper assembly the locking means are a lug-and-hole locking means, providing a robust way of locking the wiper arm with respect to the support member.

In an embodiment of the wiper assembly the wiper arm is rotatable over at least an angle of 90 degrees around said second axis of rotation, preferably over at least an angle of 180 degrees around said second axis of rotation, so that the user has good access to the wiper blade to be replaced.

In an embodiment of the wiper assembly the wiper arm comprises an elongate section comprising a structural member consisting of a single high-tensile strength material surrounded by an outer sleeve. This provides a very strong wiper arm that has very good mechanical properties.

In an embodiment of the wiper assembly the high-tensile strength material is chosen from a group of materials having a tensile strength of larger than 1000 MPA, in particular more than 1500 MPA, more in particular more than 1800 MPA, preferably chosen from a group of materials comprising a high-tensile steel composition. This provides a composite wiper arm having very good mechanical properties.

In an embodiment of the wiper assembly the structural member is one of a wire, a sheet and a tubular member. This improves manufacturability of the composite wiper arm.

In an embodiment of the wiper assembly the structural member projects into the passage and defines the second axis of rotation. This improves structural integrity and strength of the wiper arm.

### BRIEF DESCRIPTION OF THE DRAWINGS

Further advantageous embodiments of the wiper assembly according to the invention are described in the claims and in the following description with reference to the drawing, in which:

FIG. 1 depicts in a plan view a wiper assembly according to the invention as installed on a partly shown motor vehicle;

FIG. 2a depicts in a cross-sectional view of a part of a first embodiment of the wiper assembly according to the invention;

FIG. 2b depicts in a schematic view the wiper assembly of FIG. 2A in a non-operable position;

FIG. 3a depicts in a cross-sectional view of a part of a second embodiment of the wiper assembly according to the invention;

FIG. 3b depicts a cross-section of a first embodiment along the plane D-D of FIG. 3a;

FIG. 3c depicts a cross-section of a second embodiment along the plane D-D of FIG. 3a;

FIG. 4 depicts in a cross-sectional view part of a third embodiment of the wiper assembly according to the invention, and

FIG. 5 depicts in a cross-sectional view part of a fourth embodiment of the wiper assembly according to the invention.

### DETAILED DESCRIPTION OF EXAMPLES

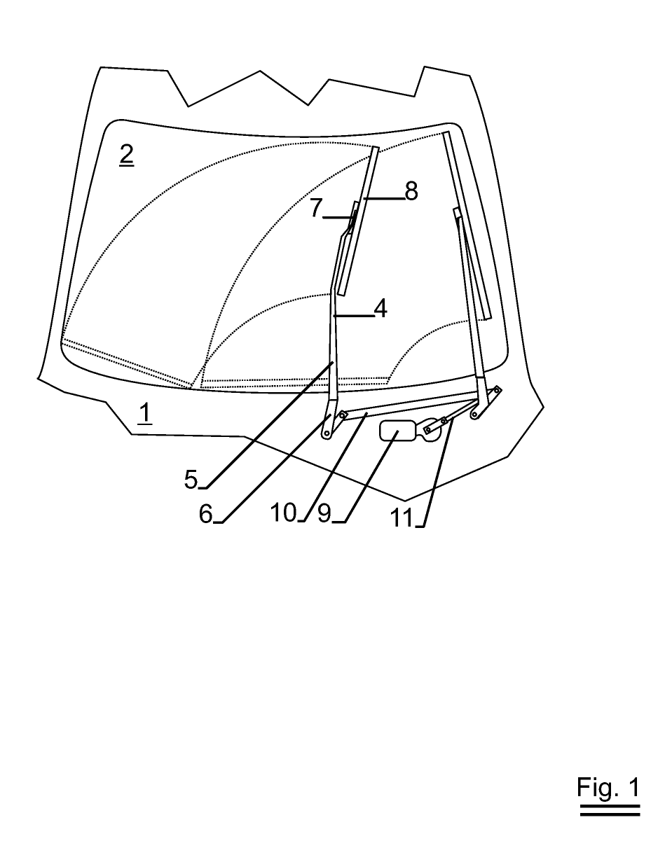

FIG. 1 schematically shows a part of a motor vehicle 1 such as a car having a window pane 2. The motor vehicle 1 comprises a set of wiper assemblies 3 which are provided for wiping the window pane 2, such as for example during rain. The motor vehicle 1 in the example of FIG. 1 comprises a set of two wiper assemblies 3 which together cover most of the surface area of the window pane 2. It is of course also possible than a different number of assemblies is provided, depending on the surface area to be covered or from a point of view of costs. Hereinafter, the invention will be described with reference to a single wiper assembly only, however the invention is of course not limited thereto.

Each wiper assemblies 3 each comprise a wiper arm 4 that on a first free end 5 thereof is coupled to by a support member 6. On a second free end 7 thereof the wiper arm 4 comprises connection means (not shown in detail) that can couple with a wiper blade 8 that is in contact with the window pane 2. The support member 6 is driven by means of a drive motor 9 and an assembly of levers 10, 11 to perform a reciprocal movement over the window pane 2 as is indicated in FIG. 1 with dotted lines. This is known as such to a person skilled in the art.

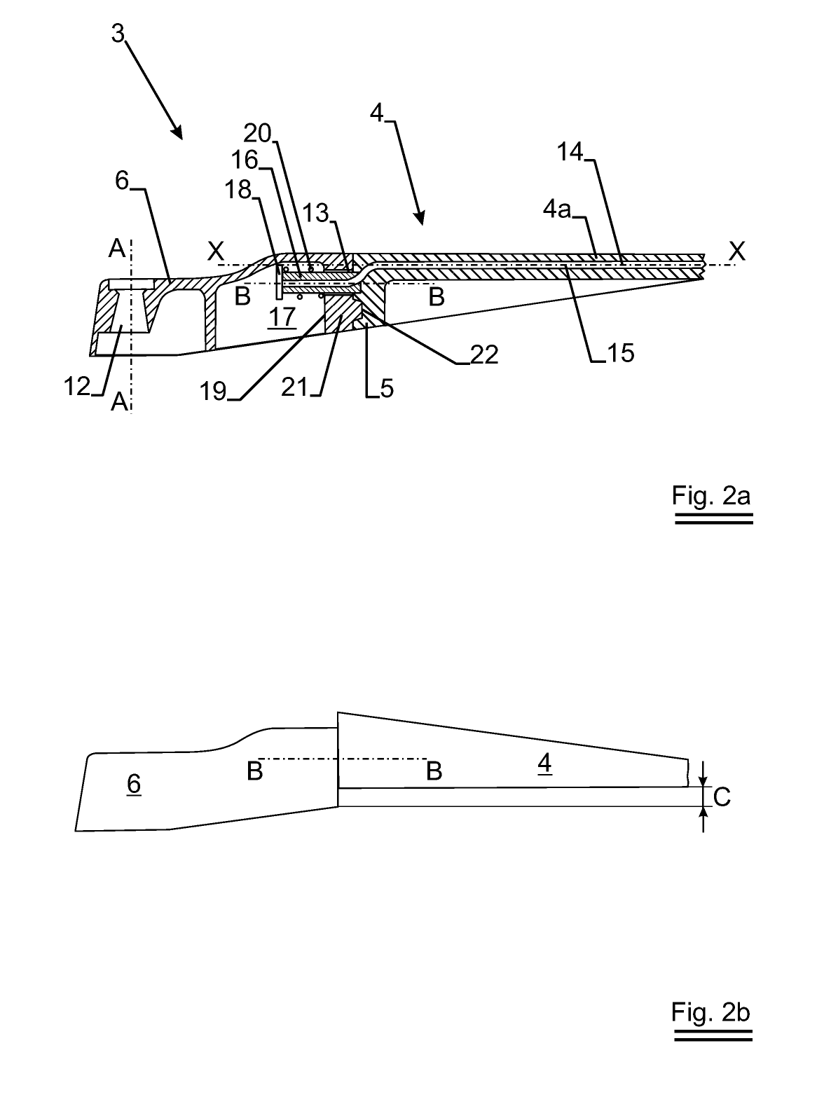

FIG. 2a shows part of a first embodiment of the wiper assembly 3 in more detail in cross-section. The wiper assembly 3 can be seen to comprise the support member 6 that is coupled to the wiper arm 4 at the first free end 5 thereof. The support member 6 comprises a coupling part 12 that can be coupled to one of the levers 10, 11 or directly to a drive shaft (not shown) of the drive motor 9 (see FIG. 1), such that the support member 6 is rotatable around a first axis of rotation A-A.

The support member 6 is provided with a passage 13 into which the free end 5 of the wiper arm 4, at least partly, projects. The free and 5 of the wiper arm 4 and the passage 13 define a second axis of rotation B-B about which the wiper arm 4 is rotatable. In the example of FIG. 2a the second axis of rotation B-B is parallel with a longitudinal axis of the wiper arm 4. As can be seen, the first axis of rotation A-A extends substantially transversely to the longitudinal axis X-X of the wiper arm 4.

The wiper arm 4 is preferably, as shown in the example of FIG. 2a, a so-called composite wiper arm. In the example of FIG. 2A the wiper arm 4 comprises an elongate section 4a comprising a structural member 14 consisting of a single high-tensile strength material surrounded by an outer sleeve 15. The high-tensile strength material can be chosen from a group of materials having a tensile strength of larger than 800 MPa, e.g. more than 1000 MPa, in particular more than 1500 MPa, more in particular more than 1800 MPA. More preferably such material is chosen from a group of materials comprising a high-tensile steel composition.

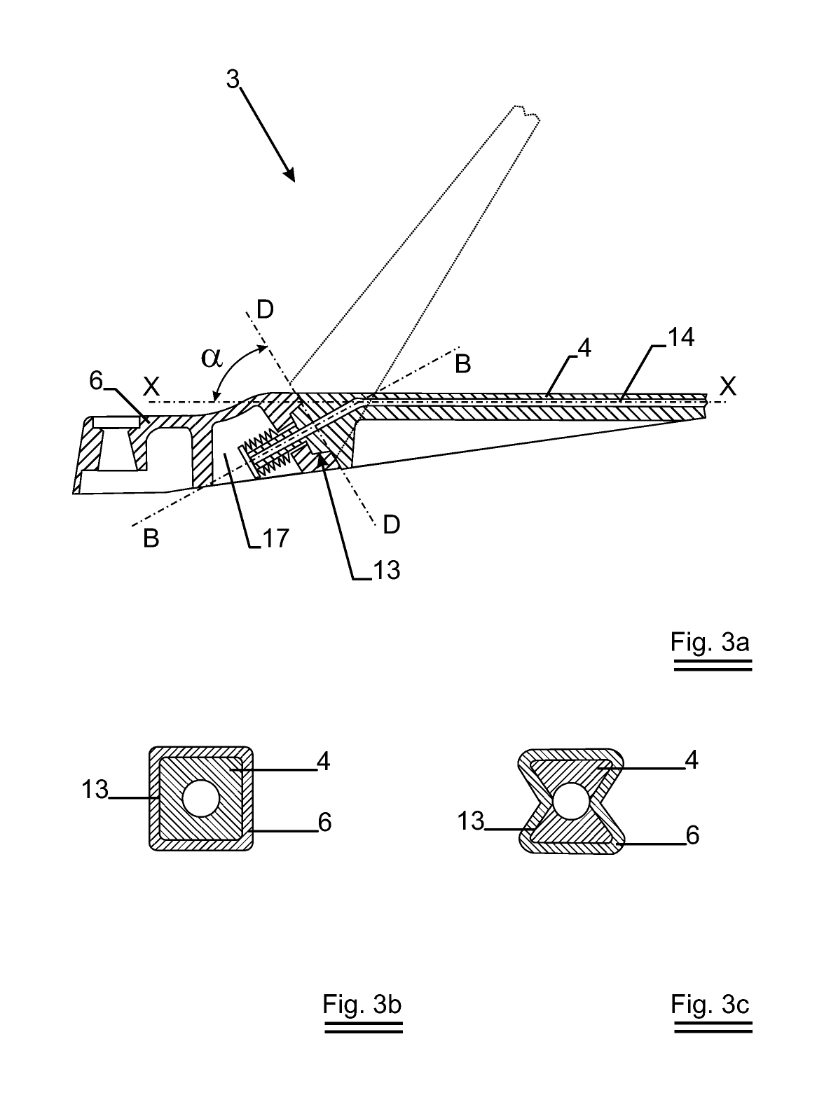

The structural member 14 together with a bush 16 project into the passage 13. The bush 16 may be a separate part as shown in FIG. 2a, but may also be an integral part of the wiper arm 4, in particular when the outer sleeve 15 thereof is made from a plastic material (see FIG. 3), the bush 16 is dimensioned such, that it closely fits into the passage 13 but still allows easy rotation of the wiper arm 4. As can be seen further in FIG. 2a, the free end 5 of the wiper arm 4, and in particular that part of the structural member 14 together with the bush 16, extends into an interior space 17. The structural member 14 is on its distal end section that projects into the interior space 17 provided with a disc-shaped support element 18 which has a larger diameter than the bush 16. Between the support element 18 and an inner surface 19 of the interior space 17, surrounding the bush 16, resilient member 20 is provided, such as a compression spring. The resilient member 20 is pre-tensioned and urges the wiper arm 4 against the support member 6 as it is compressed between the support member 18 and the inner surface 19.

The resilient member 20 is not fully compressed so as to allow for the wiper arm 4 to be axially moveable in the passage 13. In the situation as shown in FIG. 2a the wiper arm is in a so-called operable position in which it can be used to wipe a (non-shown) window pane. In order to prevent that the wiper arm 4 will inadvertently rotate during use, the support member 6 may comprise a notch 21 that can be housed by a recess 21 provided at the free end 5 of the wiper arm 4 (lug-and-hole). In order to rotate the wiper arm 4 around the second axis of rotation B-B, the user may pull the wiper arm 4 out of the interior space 17 against the force of the resilient member 20, so as to free the notch 21 from the recess 22. The rotation of the wiper arm 4 can for example be done over an angle of 90 degrees or 180 degrees, or any other angle that is convenient. The situation, or non-operable position of the wiper arm 4, wherein the wiper arm 4 is rotated over 180 degrees with respect to the support member 6 around the second axis of rotation B-B is shown in FIG. 2b.

It is noted that the notch 21 and recess 21, which in fact form a locking means, may further be arranged to lock the wiper arm 4 to the support member 6 in the non-operable position of the wiper arm 4 also.

In this manner releasable coupling means, generally denoted with reference numeral 23, are provided that are, at least partly, arranged in the interior space 17 and act on the free end 5 of the wiper arm 4 and the support member 6 for releasingly coupling the wiper arm 4 to the support member 6.

As can be seen in FIG. 2a, the second axis of rotation B-B is different from the longitudinal axis X-X of the wiper arm 4, i.e. the second axis of rotation B-B does not coincide with the longitudinal axis X-X of the wiper arm 4. In the example of FIG. 2a this is achieved by forming the structural member 14 with a double bend near the free end 5 of the wiper arm 4. In particular it can be seen that the second axis of rotation B-B is parallel to the longitudinal axis X-X, such that upon rotation of the wiper arm 4 around the second axis of rotation B-B a clearance C (see FIG. 2b). This clearance assures that a certain space exists between the wiper arm 4 and the (non-shown) window pane during replacement of the wiper blade.

A further embodiment of the wiper assembly 3 is shown in FIG. 3a, which embodiment is the same as the wiper assembly 3 of FIG. 2a except that the second axis of rotation B-B is now arranged such that is positioned under an angle α with the longitudinal axis X-X of the wiper arm 4. This has the effect, that when the wiper arm 4 is rotated about the second axis of rotation, in an manner that is similar to the manner as described with reference to FIGS. 2a and 2b, the wiper arm 4 is not only undergoes a rotational movement, but will also be swung away from the (non-shown) window pane. This is indicated in FIG. 3a by means of dotted lines which depict this non-operable position of the wiper arm 4.

The conical fixation of wiper arm 4 into support member 6 does not need to be circular in cross-section. FIG. 3b shows a cross-section according to plane D-D of FIG. 3a of a first embodiment where the cross-section is square. FIG. 3c shows a cross-section according to plane D-D of FIG. 3a of a second embodiment where the cross-section is polygonal.

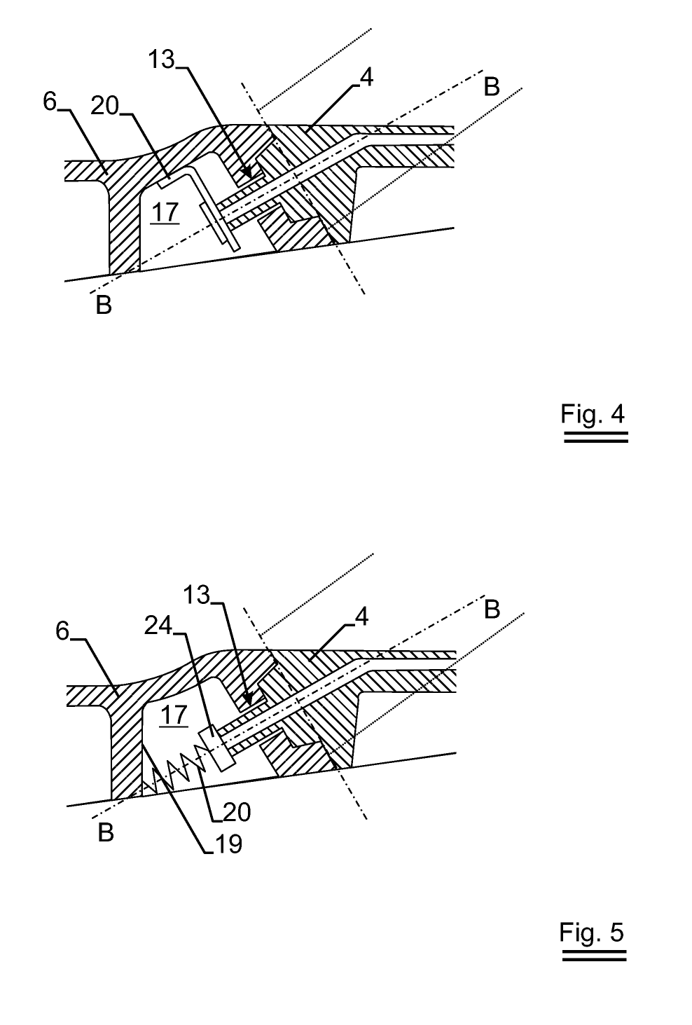

In FIGS. 4 and 5 further embodiments of the wiper assembly are shown, wherein alternative embodiments are given for the resilient member 20. FIG. 4 shows the resilient member 20 to be a leaf spring. The shorter side of the leaf spring 20 is fixed to the support member 6. The longer section has a hole where the end of the wiper arm goes through. When the arm is pulled out, the spring deflects. The end of wiper arm 4 has some clearance in the hole of the leaf spring 20 to allow a certain movement.

FIG. 5 shows the resilient member 20 to be a tension spring that is attached to a part of the inner surface 19 of the inner space 17 that is located opposite the passage 13. An end stop 24, e.g. a bush, may be connected to the end of the wiper arm 4 in order to prevent the wiper arm 4 from being pulled out completely and the spring 20 from being damaged or even destroyed.

It is noted, however, that other solutions for the resilient member 20 are also conceivable and that the embodiments shown are merely provided as an example and are not intended to limit the invention in any way.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

### LIST OF ELEMENTS

A-A first axis of rotation
B-B second axis of rotation
X-X longitudinal axis of wiper arm
C clearance
1 motor vehicle
2 window pane
3 wiper assembly
4 wiper arm
4a elongate section
5 first free end of wiper arm
6 support member
7 second free end of wiper arm
8 wiper blade
9 drive motor
10 lever
11 lever
12 coupling part
13 passage
14 structural member
15 outer sleeve
16 bush
17 interior space
18 support element
19 inner surface
20 resilient member
21 recess
22 cut-out
23 releasable coupling means
24 end stop

1. A wiper assembly (3) comprising a wiper arm (4) having a longitudinal axis (X-X) and arranged to carry a wiper blade (8), the wiper arm (4) comprising a free end (5) forming one single piece with said wiper arm or being fixedly connected to said wiper min (4),
the wiper assembly further comprising a support member (6) rotatable around a first axis of rotation (A-A) extending substantially transversely to said longitudinal axis (X-X) of the wiper arm (4),
said support member (6) being arranged to support the wiper min (4) through said free end (5), characterized in that
the support member (6) comprises a passage (13) into which the free end (5) of the wiper arm (4), at least partly, projects, and wherein the free and (5) of the wiper arm (4) and the passage (13) define a second axis of rotation (B-B) about which the wiper arm (4) is rotatable,
and in that the second axis of rotation (B-B) is different from the longitudinal axis (X-X) of the wiper arm (4) so as to provide a clearance between the wiper arm and a window pane.

2. The wiper assembly (3) according to claim 1, wherein the second axis of rotation (B-B) is substantially parallel with the longitudinal axis (X-X) of the wiper arm (4).

3. The wiper assembly (3) according to claim 1, wherein the second axis of rotation (B-B) is angled with respect to the longitudinal axis (X-X) of the wiper arm (4).

4. The wiper assembly (3) according to claim 1, wherein the passage (13) has a substantial circular cross-section and the free end (5) of the wiper aim (4) projecting, at least partly, in said passage has a corresponding cross-section.

5. The wiper assembly (3) according to claim 1, wherein the passage (13) has a non-circular cross-section and the free end (5) of the wiper arm (4) projecting, at least partly, in said passage has a corresponding cross-section.

6. The wiper assembly (3) according to claim 1, wherein the passage (13) extends into an interior space (17) of the support member (6) and the free end (5) of the wiper arm (4) projects into said interior space (17), and wherein the wiper assembly (3) further comprises releasable coupling means, at least partly, arranged in the interior space (17) acting on the free end (5) of the wiper arm (4) and said support member (6) for releasingly coupling the wiper arm (4) to the support member (6).

7. The wiper assembly (3) according to claim 6, wherein the free end (5) of the wiper arm (4) is axially moveable in said passage (13), and wherein the coupling means comprise a resilient member (20) for urging the wiper arm (4) against the support member (6).

8. The wiper assembly (3) according to claim 7, wherein the resilient member (20) is a helical spring arranged between and acting upon a distal end of the wiper arm (4) and an inner surface (19) of said interior space (17).

9. The wiper assembly (3) according to claim 1, further comprising locking means (21, 22) arranged to lock the wiper arm (4) to the support member (6) in at least an operable position of the wiper assembly (3).

10. The wiper assembly (3) according to claim 9, wherein the locking means (21, 22) are further arranged to lock the wiper arm (4) to the support member (6) in a non-operable position of the wiper assembly (3) different from the operable position.

11. The wiper assembly (3) according to claim 10, wherein the locking means (21, 22) are a lug-and-hole locking means.

12. The wiper assembly (3) according to claim 1, wherein the wiper arm (4) is rotatable over at least an angle of 90 degrees around said second axis of rotation (B), preferably over at least an angle of 180 degrees around said second axis of rotation (B).

13. The wiper assembly (3) according to claim 12, wherein the wiper arm (4) comprises an elongate section (4a) comprising a structural member (14) consisting of a single high-tensile strength material surrounded by an outer sleeve (15).

14. The wiper assembly (3) according to claim 13, wherein the structural member (14) is one of a wire, a sheet and a tubular member.

15. The wiper assembly (3) according to claim 14, wherein the structural member (14) projects into the passage (13) and defines the second axis of rotation (B).
